(19) United States
(12) Patent Application Publication
(10) Pub. No.: US 2004/0186761 A1
(43) Pub. Date: Sep. 23, 2004

(54) Method and system for logistical management of import and export goods

(76) Inventors: Yun-Chi Lee, Taipei (TW); Wen-Yi Chang, Taipei (TW); Yueh-Chiu Lin, Taipei (TW)

Correspondence Address: FULBRIGHT AND JAWORSKI L L P, PATENT DOCKETING 29TH FLOOR, 865 SOUTH FIGUEROA STREET, LOS ANGELES, CA, 900172576

(21) Appl. No.: 10/394,909

(22) Filed: Mar. 20, 2003

(51) Int. Cl. G06F 17/60

(52) U.S. Cl. 705/8

(57) ABSTRACT

A method and a system for logistical management of import and export goods are provided for use with a network communication system which allows users to instantly obtain import and export information such as import information, export delivery details, and so on through the network. Partnering imports and exporters can log in the system and connect to an import information inquiry module and an export information inquiry module respectively to inquire import information and export information respectively. By the above method and system, corporate internals, declaration companies, importers and exporters can be instantly informed of import and export related information, thereby reducing the effort of data reentry and cutting down costs on faxes and phone calls as compared to prior art.

### FIELD OF THE INVENTION

The present invention relates to network communication technology, and more particularly, to a method and a system for logistical management of import and export goods by which partnering importers and exporters can instantly obtain import and export related information.

### BACKGROUND OF THE INVENTION

The local Taiwanese electronics manufacturers of OEM products purchase parts and components from overseas manufacturers and assemble them together then export them out to the manufacturers that place the orders. During the exportation of goods regardless of by air or sea, a declaration process must be required which involves import and export declaration related information such as importer, declaration unit, bill no., bill sub. no., trading agreement, count, gross total weight, gross net weight, total value, and customs control number, and the like import related information. Conventional declaration form information process inputs the detailed information into a computer or information processing unit when the declaration form is received. When a user wants to inquire, the information will be printed out from the computer. Although storing information in a computer provides a certain level of convenience, the user performing the inquiry has to be physically at a computer that is connected to the database of the declaration information. Therefore this system is only suitable for corporate internals and cannot allow remote users to inquire using the computer which in fact requires a third person to deliver the information of the declaration form by means of fax or other conventional methods. Furthermore, the increase in information transmission will correspondingly affect the accuracy and availability of the information.

### SUMMARY OF THE INVENTION

Due to the disadvantages of the prior art, a primary objective of the present invention is to provide a method and a system for logistical management of import and export of goods which can reduce human error.

Another objective of the present invention is to provide a method and a system for logistical management of import and export goods which can increase import and export information flow efficiency and management.

According to the above and other objectives, the system for logistical management of import and export goods according to the present invention is disposed in a web server which is connected to a network infrastructure. The network infrastructure is further connected to a plurality of end-user terminals. The system for logistical management of import and export goods comprises: an import and export information database which has an import information chart and an export information chart; an import inquiry module for providing a login web page for the terminals for receiving an inquiry request via an online inquiry to the import information chart in the import and export information database and for displaying the inquiry results on the terminals; and an export inquiry module for providing a login web page for the terminals for receiving an inquiry request via an online inquiry to the export information chart in the import and export information database and for displaying the inquiry results on the terminals.

According to the above system, the present invention resides in a logistical management system for import and export goods, the method comprises: (1) creating an import and output information database in the logistical management system with an import information chart which has a plurality of fields for storing corresponding import information and an export information chart which has a plurality of fields for storing corresponding export information; (2) connecting a user at a terminal to the logistical management system for import and export goods in the web server via a network infrastructure to inquire import information, proceed to step (3); if one wishes to inquire export information, proceed to step (4); (3) connecting to an import inquiry module for providing an import information inquiry web page to the terminal to allow users to submit an inquiry request to the import inquiry module, the import inquiry module receives the inquiry request and connects to the import information chart in the import and export database to locate the import information in the fields and output them to the terminal; and (4) connecting to an export inquiry module for providing an export information inquiry web page to the terminal to allow users to submit an inquiry request to the export inquiry module, the export inquiry module receives the inquiry request and connects to the export information chart in the import and export database to locate the export information in the fields and output them to the terminal. Comparing to the prior art, the method and system for logistical management of import and export goods of the present invention provides corporate internals, declaration companies, importers and exporters with instant and online notice of import and export related information using the method and system which reduces the effort of data reentry and cuts down on faxes and phone calls.

### BRIEF DESCRIPTION OF THE DRAWINGS

The present invention can be more fully understood by reading the following detailed description of the preferred embodiments, with reference made to the accompanying drawings, wherein:

FIG. 1 is a schematic diagram of the structure of the system for logistical management of import and export goods according to a preferred embodiment of the present invention;

FIG. 2 is a schematic inquiry web page provided by the import information inquiry module of the present invention;

FIG. 3 is a schematic inquiry results web page provided by the import information inquiry module of the present invention;

FIG. 4 is a schematic inquiry web page provided by the export information inquiry module of the present invention;

FIG. 5 is a schematic inquiry results web page provided by the export information inquiry module of the present invention; and

FIG. 6 is a flow chart of the method for logistical management of import and export goods according to a preferred embodiment of the present invention.

### DETAILED DESCRIPTION OF THE PREFERRED EMBODIMENT

The following complements on the diagrams which describes in detail the wireless transaction information processing system and method according to one preferred embodiment of the present invention.

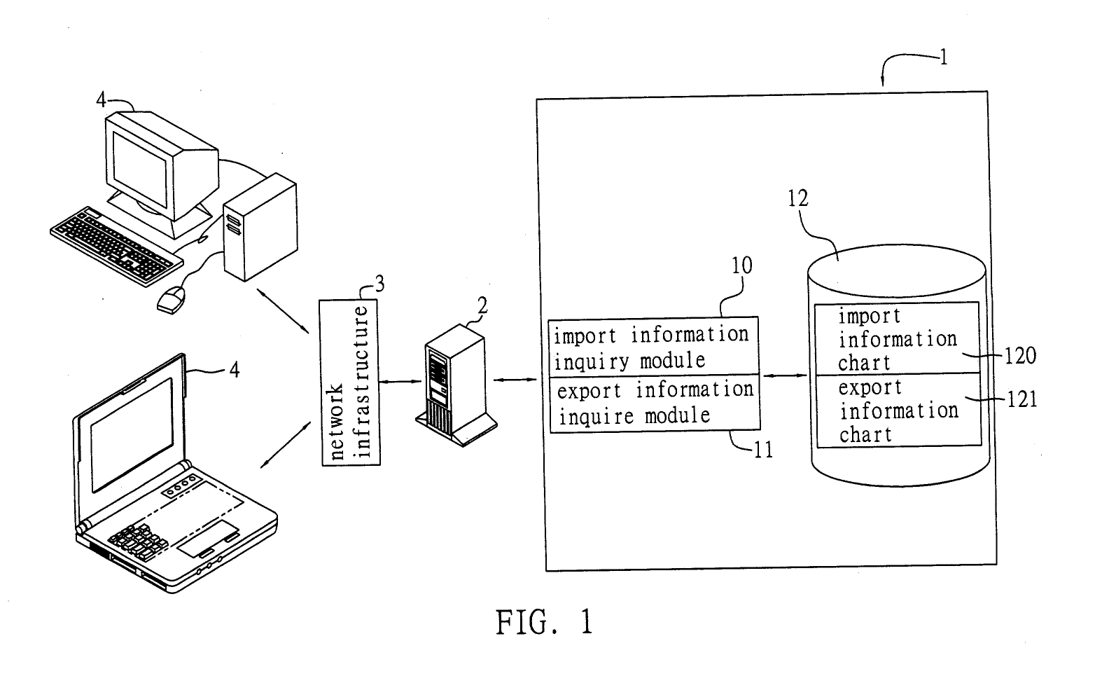

As shown in FIG. 1, the method and system for logistical management 1 of import and export goods of the present invention is disposed in a web server 2 which is connected to a network infrastructure 3 of Intranet or Internet. The network infrastructure 3 is further connected to a plurality of terminals 4 (such as desktop computers, portable computers, or personal digital assistant (PDA)). The logistical management system 1 comprises an import and export information database 12, an import information inquiry module 10, and an export inquiry module 11.

The import and export information database 12 stores an import information chart 120 and an export information chart 121, wherein the import information chart 120 further comprises a plurality of fields (in this preferred embodiment they include monitoring number, declaration unit, form type and the like fields (not shown)) for storing the corresponding import information, and the export information chart 121 further comprises a plurality of fields (in this preferred embodiment they include outsource company, monitoring number, form type, invoice date, and the like fields (not shown)) for storing the corresponding export information.

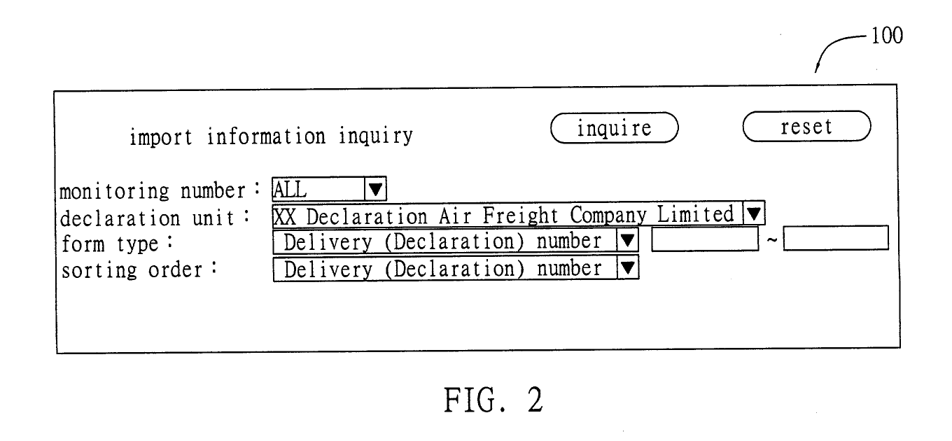

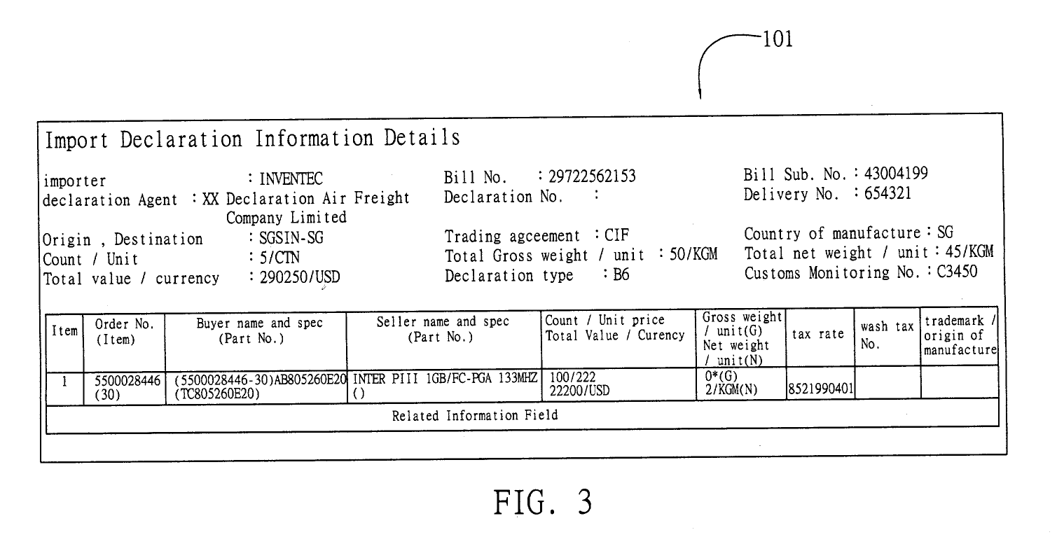

The import information inquiry module 10 provides an import information inquiry web page 100 for logged in users as shown in FIG. 2 which includes monitoring number, declaration unit, form type, sorting order, and the like fields for logged in users to input or select inquiry fields and submit the inquiry request. After a user submits an inquiry request to the import information inquiry module 10, it connects to the import information chart 120 of the import and export information database 12 to extract the import information in the fields and execute a series of declaration details web pages 101, shown in FIG. 3, to display on the terminal of the user.

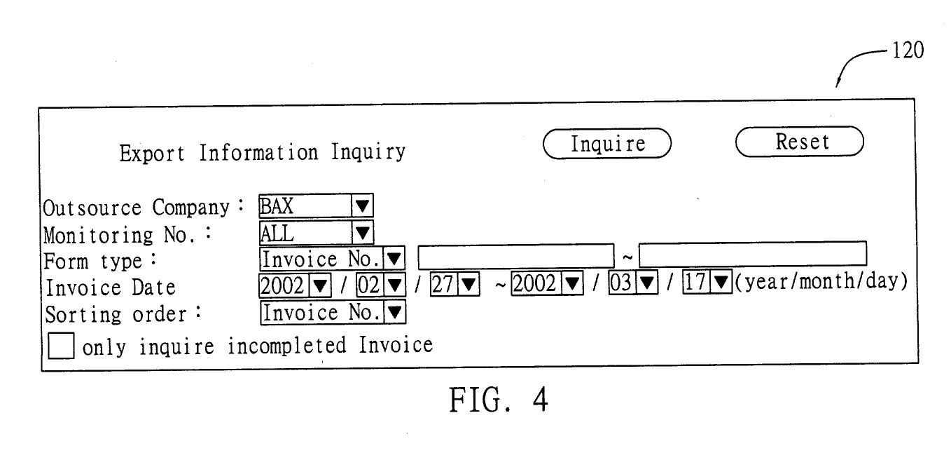

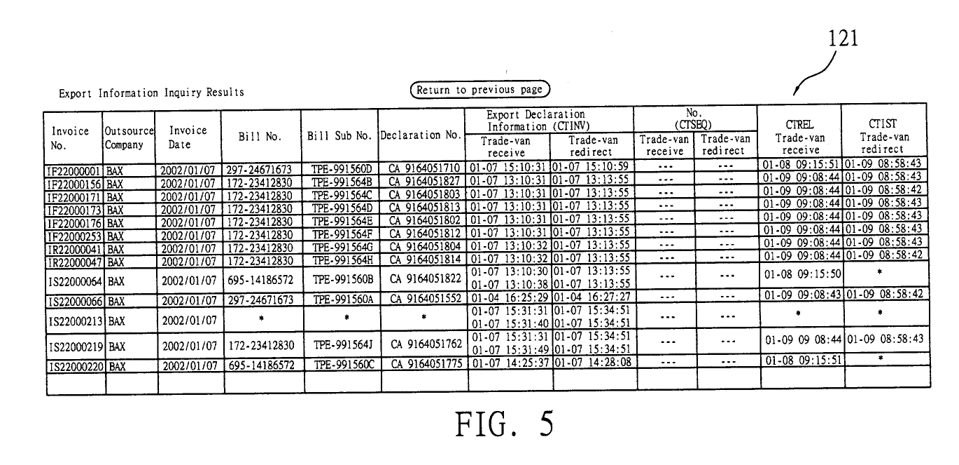

The export information inquiry module 12 provides an export information inquiry web page 120 for logged in users as shown in FIG. 4 which includes outsource company, monitoring number, form type, invoice date, sorting order, and the like fields for logged in users to input or select inquiry fields and submit the inquiry request. After a user submits an inquiry request to the export information inquiry module 12, it connects to the export information chart 121 of the import and export information database 12 to extract the export information in the fields and execute a series of declaration details web pages 101, shown in FIG. 5, to display on the terminal of the user.

During actual operation, for example a user of the corporate internal connects to the logistical management system 1 by a terminal 4 to inquire import goods information. After logging into the system, the user initiates the import information inquiry module 11 to provide an import information inquiry web page as in FIG. 2 for logged-in user. The user enters the inquiry fields for XX Declaration Air Freight Company Limited. After the import information inquiry module 111 receives the inquiry fields, the corresponding information in the import information chart 120 in the import and export information database 12 is located and is outputted to the terminal of the user. FIG. 4 shows the declaration details web page of the XX Declaration Air Freight Company Limited.

It is to be noted that the display method of the various aforementioned web pages is only an example of the preferred embodiment of the present invention, wherein the format of the displayed information can be changed at will.

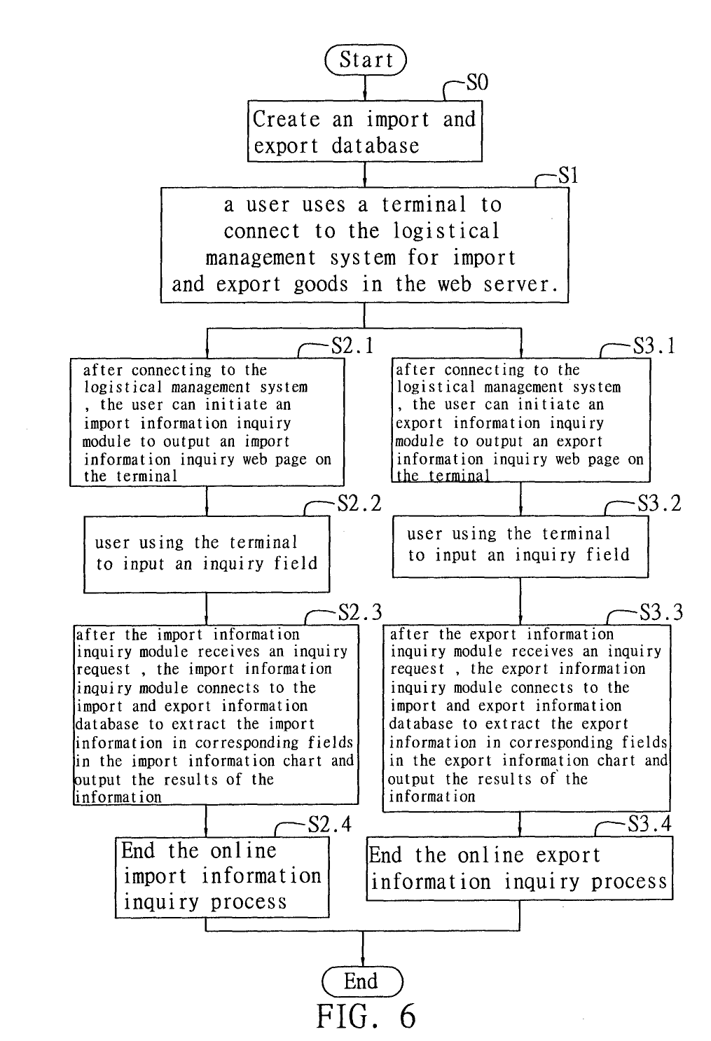

FIG. 6 is the flow chart of the method for logistical management system of import and export goods of the present invention, the method comprises:

Firstly, perform step S0 to allow a user to create an import and export information database in the logistical management system for setting up an import information chart which has a plurality of predefined fields for storing corresponding import information, and an export information chart which has a plurality of predefined fields for storing corresponding export information.

Continuing to step S1, a user uses a terminal to connect to the logistical management system for import and export goods in the web server. If the user wishes to inquire import information, the process flows to step S2.1, and if the user wishes to inquire export information, the process flows to step S3.1.

Taking step S2.1, after connecting to the logistical management system, the user can initiate an import information inquiry module to output an import information inquiry web page on the terminal such as in FIG. 2.

Following in step S2.2, the user uses a browser on the terminal to browse to the import information inquiry web page for inputting the inquiry fields according to the fields provided by the import information inquiry web page and submits an inquiry request.

Next in step S2.3, after the import information inquiry module receives an inquiry request, the import information inquiry module connects to the import and export information database to extract the import information in corresponding fields in the import information chart and to output the results of the information in the format shown in FIG. 3 to the terminal of the user.

Finally in step S.2.4, the user browses to inquiry results using the browser of the terminal and the import information inquiry process is ended.

Taking step S3.1, after connecting to the logistical management system, the user can initiate an export information inquiry module to output an export information inquiry web page on the terminal such as in FIG. 4.

Following in step S3.2, the user uses a browser on the terminal to browse to the export information inquiry web page for inputting the inquiry fields according to the fields provided by the export information inquiry web page and submits an inquiry request.

Next in step S3.3, after the export information inquiry module receives an inquiry request, the export information inquiry module connects to the import and export information database to extract the export information in corresponding fields in the export information chart and output the results of the information in the format shown in FIG. 5 to the terminal of the user.

Finally in step S.3.4, the user browses the inquiry results using the browser of the terminal and the export information inquiry process is ended.

Comparing to the prior art, the method and system for logistical management of import and export of goods of the present invention provides corporate internals, declaration companies, importers and exporters with instant and online notice of import and export related information using the method and system which reduces the effort of data reentry and cuts down on faxes and phone calls.

The present invention has been described using exemplary preferred embodiments. However, it is to be understood that the scope of the invention is not limited to the disclosed embodiments. On the contrary, it is intended to cover various modifications and similar arrangements. The scope of the claims, therefore, should be accorded the broadest interpretation so as to encompass all such modifications and similar arrangements.

What is claimed is:

1. A logistical management system for import and export goods, for use with a web server which is coupled to a network infrastructure associated with a plurality of terminals, the system comprising:
an import and export database comprising an import information chart and an export information chart, wherein the import information chart has a plurality of predefined fields for storing corresponding import information, and the export information chart has a plurality of predefined fields for storing corresponding export information;
an import information inquiry module for providing a login terminal with an inquiry web page which allows a user to submit an inquiry request via the terminal, and for coupling to the import and export information database to obtain import information from the import information chart according to the inquiry request and output the obtained information to the terminal of the user when the inquiry request is received by the import information inquiry module; and
an export information inquiry module for providing a login terminal with an inquiry web page which allows a user to submit an inquiry request via the terminal, and for coupling to the export and export information database to obtain export information from the export information chart according to the inquiry request and output the obtained information to the terminal of the user when the inquiry request is received by the export information inquiry module.

2. The system of claim 1, wherein the import information chart comprises monitoring numbers, declaration units, form types, and import information that corresponds to the monitoring numbers, declaration units and form types.

3. The system of claim 1, where the export information chart comprises outsource companies, monitoring numbers, form types, and export information that corresponds to the outsource companies, monitoring numbers and form types.

4. The system of claim 1, wherein the terminal is a desktop computer equipped with online ability.

5. The system of claim 1, wherein the terminal is a portable computer equipped with online ability.

6. A logistical management method for import and export goods for use with a logistical management system for import and export goods, which logistical management system is established in a web server connected to a network infrastructure, the method comprising the steps of:
(1) creating an import and export information database in the logistical management system to set up an import information chart which has a plurality of predefined fields for storing corresponding import information and to set up an export information chart which has a plurality of predefined fields for storing corresponding export information;
(2) connecting a user at a terminal to the logistical management system in the web server via the network infrastructure; if the user wishes to inquire import information, going to step (3); if the user wishes to inquire export information, going to step (4);
(3) connecting to an import inquiry module for providing an import information inquiry web page to the terminal to allow the user to submit an inquiry request to the import inquiry module, whereby upon receiving the inquiry request, the import inquiry module connects to the import and export database to obtain import information from the import information chart according to the inquiry request and outputs the obtained information to the terminal of the user; and
(4) connecting to an export inquiry module for providing an export information inquiry web page to the terminal to allow the user to submit an inquiry request to the export inquiry module, whereby upon receiving the inquiry request, the export inquiry module connects to the import and export database to obtain export information from the export information chart according to the inquiry request and outputs the obtained information to the terminal of the user.

7. The method of claim 6, wherein in step (1), the import information chart comprises monitoring numbers, declaration units, form types, and import information that corresponds to the monitoring numbers, declaration units and form types.

8. The method of claim 6, wherein in step (1), the export information chart comprises outsource companies, monitoring numbers, form types, and export information that corresponds to the outsource companies, monitoring numbers and form types.

9. The method of claim 6, wherein the terminal is a desktop computer equipped with online ability.

10. The method of claim 6, wherein the terminal is a portable computer equipped with online ability.
